(19) United States
(12) Patent Application Publication
(10) Pub. No.: US 2021/0148330 A1
(43) Pub. Date: May 20, 2021

(54) A DISMOUNTABLE WIND POWER PLANT WITH ROTATION AXIS SUBSTANTIALLY PERPENDICULAR TO THE WIND DIRECTION AND A METHOD FOR MOUNTING THE WIND POWER PLANT

(71) Applicant: WINDESTER OY, Hameenlinna (FI)

(72) Inventor: Jouni KUKKONEN, Kangasala (FI)

(73) Assignee: WINDESTER OY, Hameenlinna (FI)

(21) Appl. No.: 16/611,585

(22) PCT Filed: May 17, 2018
(86) PCT No.: PCT/FI2018/050368

§ 371 Date: Nov. 7, 2019

(30) Foreign Application Priority Data
May 18, 2017 (FI) U20170099
Feb. 8, 2018 (FI) U20180026

(51) Int. Cl. F03D 3/02; F03D 13/20; F03D 3/06

(52) U.S. Cl. CPC F03D 3/02; F03D 13/20; F03D 3/062; F05B 2240/93; F05B 2240/917; F05B 2230/60; F05B 2240/913; F05B 2240/211

(57) ABSTRACT

A dismountable wind power plant with rotation axis substantially perpendicular to the wind direction is disclosed. The sail structure may form a Savonius type turbine when the power plant is in tensioned state, having two semicylindrical sails (5) facing opposite directions. Sails (5) are tensioned between transverse bars (6, 7), wherein the transverse bars (6, 7) provide the shape to the sails (5). The wind power plant is tensioned with a cable (8) between two fixed support points (3, 4). In one example the bottom portion of the power plant is connected to lower fixed support point (4) and the cable (8) to upper fixed support point (3). The cable (8) is tightened, causing the soft sail (5) to stiffen into its functional form. A generator (2) receives the rotational energy from the turbine (5, and provides electric power to power outlet. The application also concerns a method for mounting the wind power plant.

### BACKGROUND

The invention relates to wind power plants, more specifically to portable and dismountable wind power plants having a rotation axis substantially perpendicular to the wind.

The structure of known dismountable wind power plants is composed of a structure having a fixed vertical or horizontal axis. The disadvantage of such structures is that they are very heavy and often impractical to erect. Further, the fixed structure forces the size to be remain small, wherein the power inevitably remains modest. Further, among known dismountable vertical axis wind power plants are models based on a frame, around which is set, for example, a fabric, which forms the wind surface area required for the operation. The power remains modest also in this kind of model, the power/weight ratio being, however, better than in fixed solutions.

The structure of known vertical axis wind power plants is composed of blades and a generator, which are installed, for example, to the top of a mast in order to achieve optimal wind conditions. The disadvantage of such structures is that they cause a large bending moment to the mast, wherein the mast must be made very sturdy, and further, particular attention must be paid to providing adequate foundations for the mast. Vertical axis power plants output less power than horizontal axis power plants using the same surface area. If significant outputs were desired, it was necessary to make the surface area large, which, at the same time, further increased the load on the mast. Due to the sturdy mast required by the power plant, the installation of larger vertical axis wind power plants, for example, into sailboats, has been impossible in practise.

### SUMMARY

This summary is provided to introduce a selection of concepts in a simplified form that will be further described below in the detailed description. This summary is intended to neither identify key features or essential features of the claimed subject matter nor to be used to limit the scope of the claimed subject matter. Furthermore, the claimed subject matter is not limited to implementations that solve any or all of the disadvantages noted in any part of this disclosure.

A dismountable wind power plant with rotation axis substantially perpendicular to the wind direction is disclosed. The definition of axis being substantially perpendicular may refer to at least one substantial vector of the wind being perpendicular to the axis. The wind power plant has small radius compared to the length of the structure. A wind turbine portion of the power plant comprises at least two rotating sail structures.

The sail structure may form a Savonius type turbine or a modified Savonius type turbine when the power plant is in tensioned state, having two semicylindrical sails facing opposite directions. Sails are tensioned between transverse bars, wherein the transverse bars provide the shape to the sails. The wind turbine may be installed vertically, wherein it is suitable for receiving wind from all horizontal angles. The wind turbine may be installed horizontally, causing the turbine to receive the vector of the wind being perpendicular to the rotational axis. Tilted mounting positions are also possible.

The wind power plant is tensioned with a cable between two fixed support points. In one example the bottom portion of the power plant is connected to lower fixed support point and the cable to upper fixed support point. The cable is tightened, causing the soft sail to stiffen into its functional form. A generator receives the rotational energy from the turbine and provides electric power to power outlet. The electric power may be used to charge electronic devices such as smartphones, tablets, outdoor electronics, boat electronics, GPS locators, portable radios or consumer electronics. The wind turbine comprises soft sails being relatively close to the axis of rotation.

The turbine movement is safe, particularly for children and animals. The turbine speed does not exceed dangerous levels. The sails may cover the transverse bars, therefore possible contact with the rotating turbine would be a harmless slap from the sail fabric.

The wind power plant is quickly erectable, lightweight and efficient. In the dismounted state the wind power plant is small and portable, as the sails fold into small space. The wind power plant may be dismounted quickly, for example due to stormy conditions. The wind power plant may be packed into a camping bag and erected whenever there is need for a backup power source. It may be installed between two fixed support points without a sturdy mast.

Light weight and efficiency can be achieved by using only fabric and horizontal supports as the wind turbine material. When the wind power plant is used, the structure is tensioned between two fixed support points. The support points can be, for example, the ground and a tree or, alternatively, some fixed construction, such as, for example, the deck and the mast of a sailboat. Commissioning the wind power plant requires only the stretching of the structure between two support points, wherein it can be very quickly commissioned. It is possible to erect the wind power plant, for example, during a break, or overnight stay. In this case, the wind power plant is erected in an adequately windy place and it is used to charge either a separate spare battery, or directly some desired electronic device.

Many of the attendant features will be more readily appreciated as they become better understood by reference to the following detailed description considered in connection with the accompanying drawings. The embodiments described below are not limited to implementations which solve any or all the disadvantages of known portable wind power plants.

### BRIEF DESCRIPTION OF THE DRAWINGS

The present description will be better understood from the following detailed description read in light of the accompanying drawings, wherein

FIG. 1 illustrates schematically one example of an embodiment of the wind power plant;

FIG. 2 illustrates schematically one example of an embodiment of the wind power plant, wherein the wind power plant is installed onto a cable;

FIG. 3a illustrates schematically one example of an embodiment having one detail of a sail structure for the dismountable wind power plant;

FIG. 3b illustrates schematically one example of an embodiment having one detail of a sail structure for the dismountable wind power plant with two sails;

FIG. 3c illustrates schematically one example of an embodiment having one detail of a sail structure for the dismountable wind power plant;

FIG. 4 illustrates schematically one example of an embodiment of the wind power plant;

FIG. 5 illustrates schematically multiple views of one exemplary embodiment of one detail;

FIG. 6 illustrates schematically multiple views of one exemplary embodiment of one detail;

FIG. 7 illustrates schematically one example of an embodiment of the wind power plant having multiple sets of sail structures;

FIG. 8 illustrates schematically a detailed view of one exemplary embodiment of the bearing 1 and the top portion of the wind power plant.

FIG. 9 illustrates schematically one example of an embodiment of the wind power plant; and

FIG. 10 illustrates schematically one example of an embodiment having one detail of a sail structure with two sails.

Like reference numerals are used to designate like parts in the accompanying drawings.

### DETAILED DESCRIPTION

The detailed description provided below in connection with the appended drawings is intended as a description of the present examples and is not intended to represent the only forms in which the present example may be constructed or utilized. However, the same or any equivalent functions and sequences may be accomplished by different examples.

Although the present examples are described and illustrated herein as being implemented in a dismountable wind power plant and a method for mounting the wind power plant, they are provided as an example and not a limitation. As those skilled in the art will appreciate, the present examples are suitable for application in a variety of different types of dismountable wind power plants.

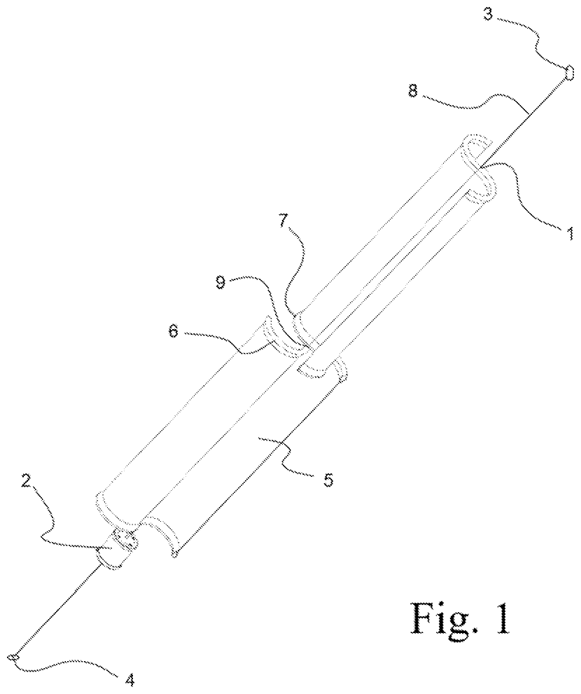

FIG. 1 illustrates schematically one example of an embodiment of the wind power plant. A dismountable vertical axis wind power plant is composed of one or more sails 5, a generator 2, a bearing 1 and a fastening cable 8. The structure is set into working condition such that the generator 2 is fastened to the lower part of the sail 5 and the bearing/cable combination 1 is fastened to the upper part of the sails 5. The generator 2 is further fastened to another support point 4, for example, to the ground. The bearing 1 and cable 8 to be fastened to the upper part of the sails 5 are further fastened to another support point 3, for example, to a tree. Finally, the structure is tensioned utilizing the cable 8 of the upper part. The sails 5 are composed of fabric or other similar flexible material and they fasten to transverse bars 6, 7 at their upper and lower parts. The bars 6, 7 are in their structure of a durable material, such as aluminium. The shape of the bars 6, 7 generally follows the shape used in the cross-section of the turbine part of vertical axis wind power plants. The shape roughly reproduces the letter S. Because the structure is under axial tension, the shape of the bars 6, 7 is further copied into the fabric. The designation “turbine” is used with a structure, having an entity formed by one or more bars 6, 7 and a sail 5.

As the wind power plant operates, wind strikes the sail 5 and, due to the shape of the bars 6, 7 and the sail 5, the wind begins to rotate the sail 5. The rotary movement is further transmitted from the lowermost sail 5 to the generator 2.

The rotary movement is transformed in the generator 2 into electrical energy and it is further utilized, for example, for the recharging of batteries. The upper end of the uppermost sail 5 is attached to the bearing 1, which enables the free rotary movement of the upper end.

In one embodiment a dismountable vertical axis wind power plant comprises one or more sails 5, one or more fastening elements 9 of the sails 5, a generator 2, a bearing 1 and a fastening cable. The sails 5 are made from soft and flexible material such as fabric. The sails comprise transverse bars 6, 7. The transverse bars 6, 7 are S-shaped. The fastening element 9 of the transverse bars 6, 7 is substantially positioned, according to its intended purpose, at a different angle to the transverse bar 6, 7. The sails 5 are, compared to one another, vertically at different angles in the fastening cable 8.

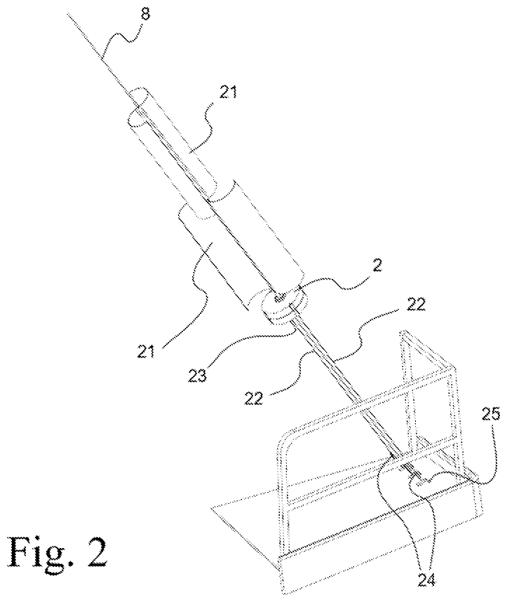

FIG. 2 illustrates schematically one example of an embodiment of the wind power plant, wherein the wind power plant is installed onto a cable 8. A hub drilling has been made into the generator 2 and the blades 21. The cable 8 is further bearing-mounted to the hub drillings, wherein the blades 21 and the rotor of the generator 2 can rotate under the force of the wind and the cable 8 and the outer part of the generator 2 remain in place. When the wind power plant is used, the cable 8 is tensioned between two fixed support points and the wind power plant is installed onto the cable 8. Support points can be, for example, the ground and a tree, or, alternatively, some kind of fixed construction, such as, for example, the deck and the mast of a boat. By means of the cable 8, a safe construction is also achieved. The cable 8 assures that if the construction were to otherwise become broken, the generator 2 is, for example, not able to fall.

The wind power plant can be installed, for example, into a sailboat, various buildings or constructions or onto telecommunications masts. By using a wind power plant it is possible to charge, for example, the accumulator battery of a ship or building, or it can be used to produce electricity, which is transferred into the electrical network, for example, via an inverter.

According to one embodiment, the vertical axis wind power plant to be installed onto a cable 8 is composed of blades 21, a generator 2, a cable 8, tensioning cables 22, a cable lock and cable tensioning means 24. In place of the cable 8, in the structure can also be utilized, for example, a rope or a string. The blades 21 follow the shapes used in vertical axis power plants. The blades 21 are in one embodiment sails 5 as disclosed in the previous example. The structure is installed between two fixed support points utilizing, for example, loops or similar fastening points. The structure is made ready for use such that the cable 8 is threaded through the blades 21 and the generator 2. The cable lock may be tensioned onto the cable 8 to a suitable height, and the generator 2 may be lowered onto the cable lock. The cable 8 is fastened between the support points and tensioned by utilizing the tensioning elements 24 of the cable. Thereafter, the tensioning cables 22 are installed into the generator 2 and also tensioned to a suitable tension by utilizing the tensioning elements 24 of the cable.

As the wind power plant operates, wind strikes the blades 21 and, due to the shape of the blades 21, the wind begins to rotate the blades 21 and, further, the thereto-connected generator 2. The rotor of the generator 2 and the blades 21 are bearing-mounted around the cable 8, wherein moment is not directed from the structure onto the cable, or the moment is exceptionally slight. The stator and outer casing of the generator 2 do not rotate under the influence of the wind, because it is supported by the cable lock and it is tensioned by the cables 8 and tensioning elements 24 to a second support point 25. The cable 8 bears nearly all axial forces, wherein the bearing loads of the vertical axis power plant to be installed onto a cable 8 remain slight. The rotary movement in the generator 2 is transformed into electrical energy and it is further utilized, for example, for the recharging of batteries.

According to one embodiment, the vertical axis wind power plant, comprises the turbine part 21, the generator 2, the cable 8, the cable lock, the tensioning cable 22 and cable tensioning means 24. The cable 8 travels through the turbine part 21 and the generator 2. In one embodiment the turbine part 21 and the generator 2 are bearing-mounted around the cable 8. In one embodiment the generator 2 is in contact with the cable lock. In one embodiment the generator 2 is fastened by the tensioning cable 22 to the fastening element 9.

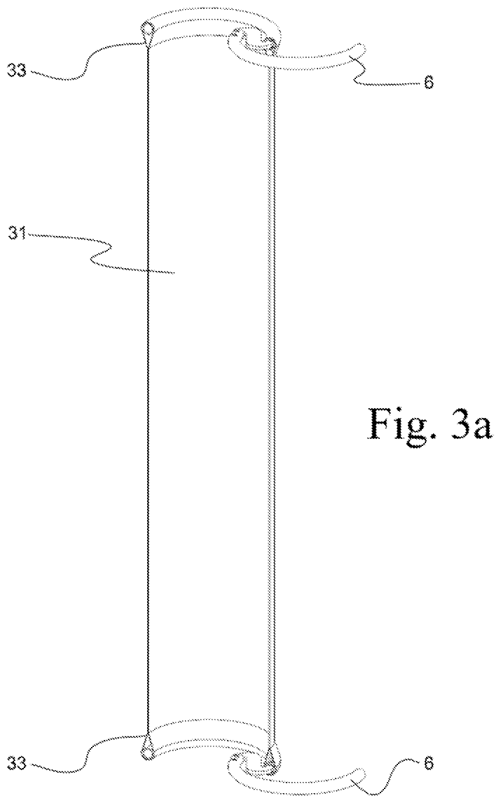

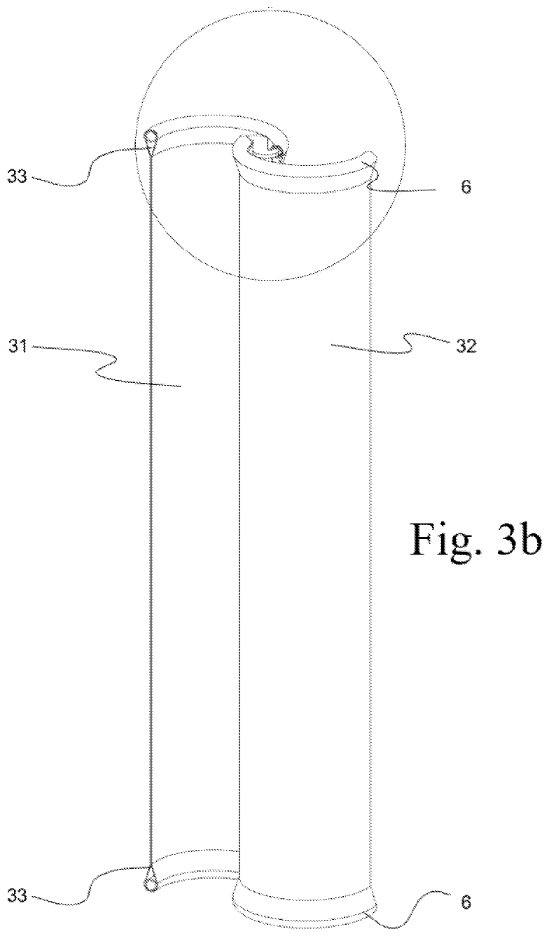

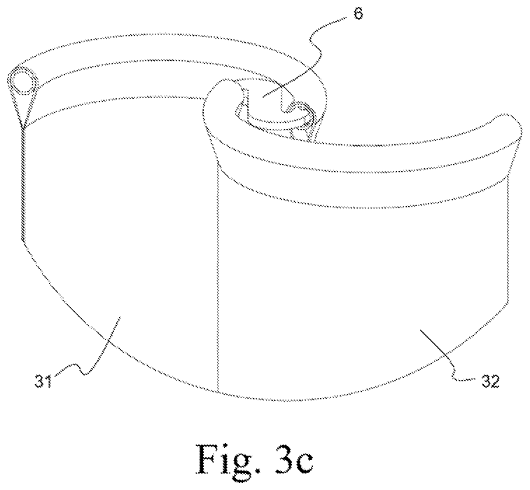

FIG. 3a discloses one exemplary embodiment of one detail of a sail structure for the dismountable wind power plant. A rotating sail structure is configured to operate in a tensioned state. A semicylindrical first sail 31 opens to a first direction. Transverse bars 6 are configured to be fastened to the top edge of the sail structure and to the bottom edge of the sail structure. In the illustrated example, the first sail 31 comprises pocket 33 to receive the transverse bar 6, wherein the transverse bars 6 provide the semicylindrical shape of the first sail 5 in the tensioned state. FIG. 3 does not illustrate the second sail that is assembled similarly to the first sail 31. The semicylindrical shape may resemble U-shape, in one embodiment the shape resembles V-shape.

FIG. 3b discloses the embodiment with the second sail 32 assembled and being in the tensioned state, illustrating one complete sail structure. The second sail 32 is parallel to the first sail 31, opening to a second direction opposite to the first direction. Together the first sail 31 and the second sail 32 form the S-shape sail structure. The sail structure's axis for rotation is in the middle of the inner edges of the first semicylindrical sail 31 and the second semicylindrical sail 31, wherein the inner edges are overlapping or connected. The transverse bar 6 allows a gap to form between the first semicylindrical sail 31 and the second semicylindrical sail 31, wherein the inner edges are overlapping and the sail structure forms a Savonius type turbine. FIG. 3c illustrates a detail of the embodiment having the transverse bar 6 inside the first semicylindrical sail 31 and the second semicylindrical sail 31.

In one exemplary embodiment the inner edges are connected and the first semicylindrical sail 31 and the second semicylindrical sail 32 for a closed Savonius type turbine, wherein the cross-section of the sails 31, 32 is S-shaped. The first sail 31 and the second sail 32 define the structure described hereinbefore as the sail 5 or the blade 5.

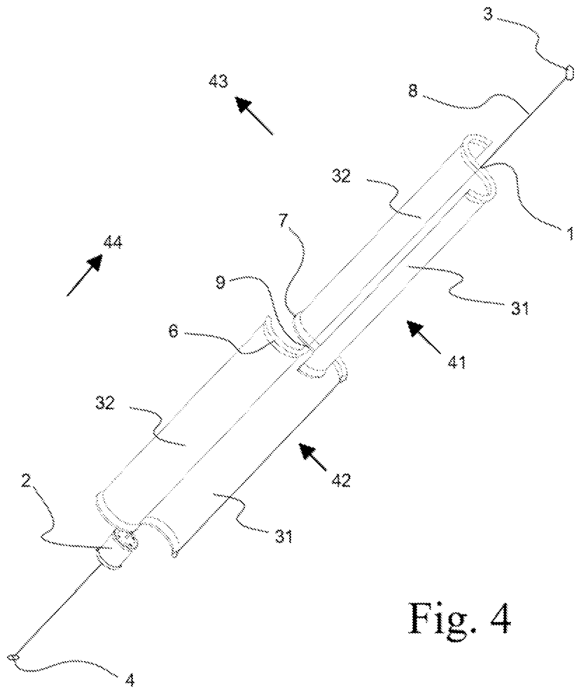

FIG. 4 is the same structure as illustrated in FIG. 1, having two sail structures being assembled as described hereinbefore. The first sail structure 41 has a first orientation 43 along the axis of rotation. In the orientation the first sail 31 and the second sail 32 face opposite directions and the orientation may be defined as a plane parallel to the directions the first semicylindrical sail 31 and the second semicylindrical sail 32 open. The second sail structure 42 has a second orientation 44 along the axis of rotation, wherein the difference between the first orientation 43 and the second orientation 44 causes the rotation of the first sail structure 41 and the second sail structure 42 to self-start when subjected to wind. The axis of rotation is defined by the cable 8. The cable 8 tensions the sail structures 41, 42. The generator 2 receives the rotation from the sail structures 41, 42 forming the turbine.

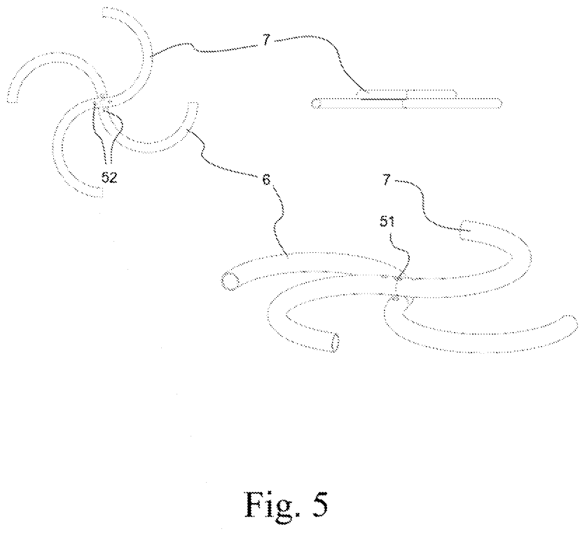

In one embodiment the transverse bars 6, 7 are S-shaped bars transversely to the axis of rotation. FIG. 5 illustrates one exemplary embodiment of the transverse bars 6, 7 from multiple projections. In this example the traverse bars 6, 7 are positioned one upon another. In one embodiment the traverse bars 6,7 are implemented as single component. The traverse bars are rigid, suitable for tensioning the sails. The traverse bars may be made of metal, aluminium, plastic or composite material. In one embodiment a bottom portion of the first sail structure 41 comprises a first transverse bar 6 and a top portion of the second sail structure 42 comprises a second transverse bar 7. The first transverse bar 6 is connected to the second transverse bar 7 at a different angle. The difference between the first orientation 43 of the first sail structure 41 and the second orientation 44 of the second sail structure 42 defines the difference between orientations. In the middle of the transverse bars 6, 7 is a first opening 51 that is in one embodiment configured to allow the cable 8 to pass through the sail structure. In one embodiment the first opening 51 is used to attach the first transverse bar 6 to the second transverse bar 7. The second openings 52 are in one embodiment configured to secure the sails to the transverse bars 6,7. In one embodiment the second opening 52 is used to attach the first transverse bar 6 to the second transverse bar 7.

In one embodiment an aluminium plate is arranged between the transverse bars 6, 7, having a bearing in the middle. The aluminium plate comprises holes matching second openings 52 of the transverse bars 6,7. Transverse bars 6, 7 may be bolted via the second openings 52 to the aluminium plate.

In one embodiment the transverse bars comprise only the first opening 51. The moment between the transverse bars 6,7 may be transferred with a keyed washer between the transverse bars 6,7. The moment may be transferred via rubber tube or plastic tube extending through the first opening 51 and having a shape configured to hinder rotation between the transverse bars 6, 7.

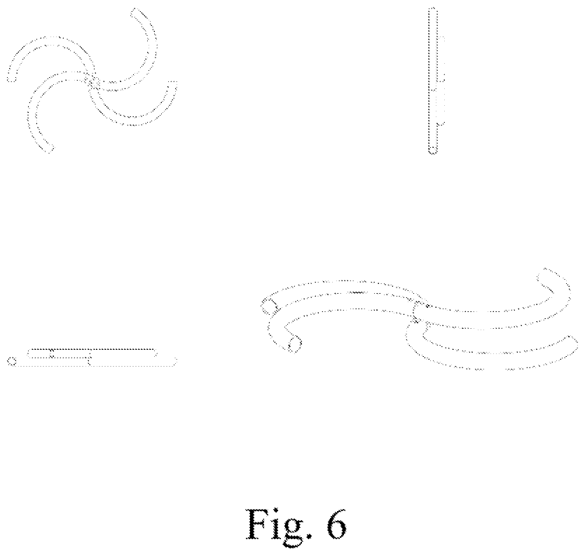

In the example of FIG. 5 the difference between transverse bars 6, 7 the first orientation and the second orientation is 90 degrees. FIG. 6 illustrates one exemplary embodiment wherein the difference between transverse bars 6, 7 the first orientation and the second orientation is 60 degrees.

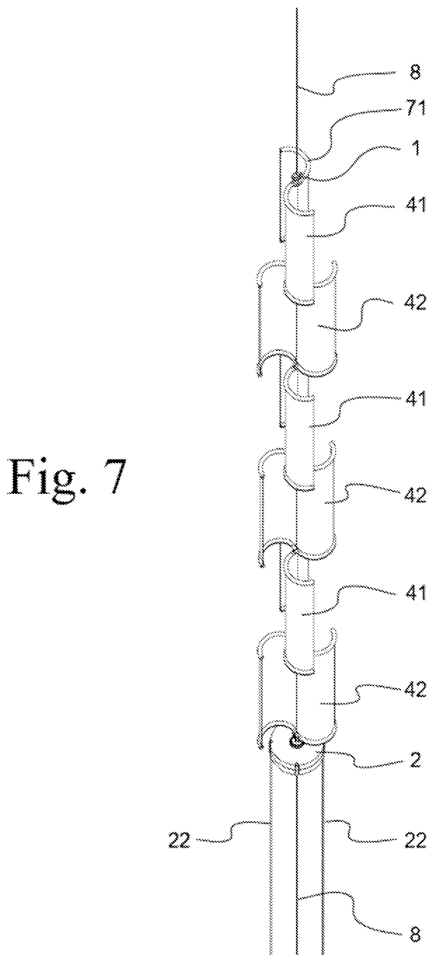

FIG. 7 illustrates schematically one exemplary embodiment having multiple sets of first sail structures 41 and second sail structures 42 with 90 degrees difference in orientation. The cable 8 is connected to a bearing 1 and the bearing 1 is connected to a top transverse bar 71. A top portion of the first sail structure 41 is connected to the top transverse bar 71. The cable 8 is configured to tension the first sail structure 41 and the second sail structure 42, or multiple sets or sail structures, by providing tension to the top transverse bar 71 when an opposite end of the wind power plant is connected to a fixed support point 4. The generator 2 comprises an opening allowing the cable 8 to travel through the generator 2 and to connect to fixed support point 4. The cable 8 may be tensioned, providing the axis of rotation to the turbine comprising the first sail structure 41 and the second sail structure 42. The turbine is connected to the cable 8 only from the top position. Tensioning cables 22 are configured to tension the first sail structure 41 and the second sail structure 42 onto the cable 8. The arrangement allows independent handling to the cable 8 and to the wind power plant. In one use scenario the cable 8 is a sailboat halyard or stay, being tightened to the top of the boat's mast. When the wind rises above suitable levels for the wind power plant, it may be removed by loosening the tensioning cables 22 and/or the bearing 1. The stator and outer casing of the generator 2 do not rotate when subjected to wind. The generator 2 is tensioned by the tensioning cables 22 to the second support point 25.

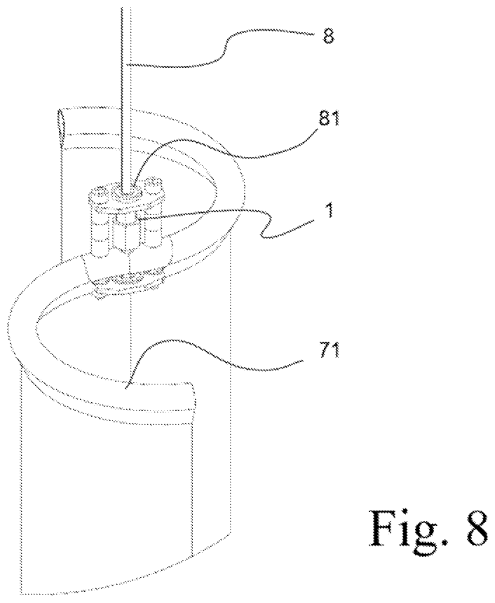

FIG. 8 illustrates a detailed view of one exemplary embodiment of the bearing 1 and the top portion of the wind power plant. The bearing 1 rotates against the cable lock 81 that is fixed to the cable 8. The cable lock 81 provides upper support point for the wind power plant, wherein the tensioning cables 22 tighten the wind power plant against the cable lock 81.

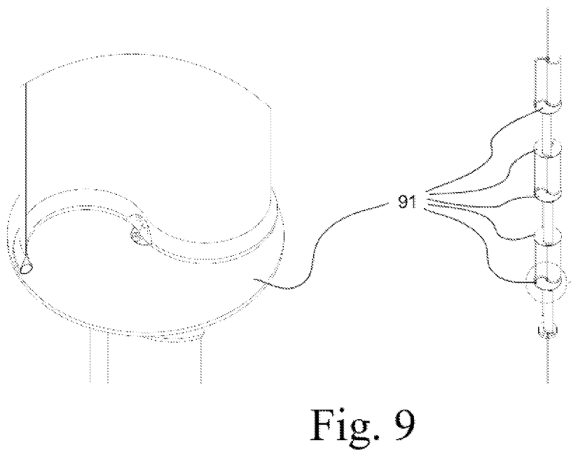

FIG. 9 illustrates schematically one exemplary embodiment, wherein the transverse bars 6, 7 are connected to a bar flange 91 positioned transversely to the axis of rotation. The bar flange 91 may improve the efficiency of the turbine. The transverse bars 6,7 may be integrated into the bar flange 91. In one embodiment the transverse bars 6,7 and the bar flange 91 are a single component.

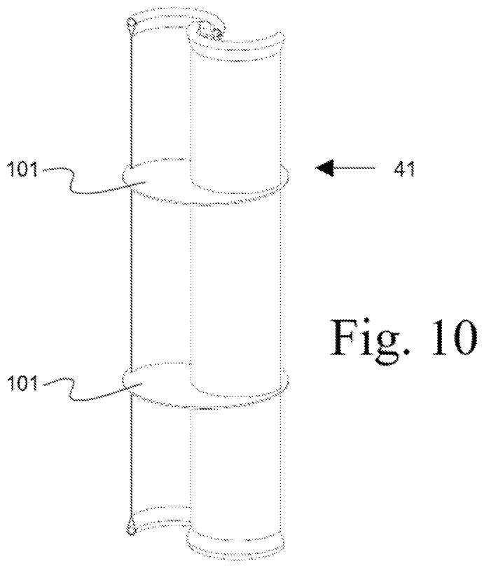

FIG. 10 illustrates schematically one exemplary embodiment of one sail structure 41. The sail structure 41 comprises multiple support flanges 101 transversely to the axis of rotation. Support flanges 101 are positioned between the top edge of the sail structure 41 and the bottom edge of the sail structure 41. The support flange 101 is configured to retain the semicylindrical sail shape in the tensioned state. The support flange 101 may be made of metal or plastic. The support flange supports the sail shape against radial forces. The sails may comprise S-shaped cross-section having one part; or Savonius type having two portions with overlapping and opening in the middle.

In one example the generator 2 comprises a USB port for connecting to the mobile equipment. The wind power plant may operate up to 600 rpm. The output may be in the range of 5V/1 A. The charging may start at the wind speed of 3 m/s. The total weight of the power plant in the portable configuration is below 1 kg. As one example, the dimensions of the portable generator may comprise length 130 mm×diameter 65 mm and the tensioned sail 230 mm×1500 mm×45 mm. The wind power plant may comprise any number of sail structures having at least two different orientations. Smaller implementations may be used for lightweight, portable camping purposes. Larger implementations, for example sail boat's wind power plants may utilize the mast height with increased number of sail structures.

A dismountable wind power plant with rotation axis substantially perpendicular to the wind direction is disclosed. The wind power plant comprises a rotating sail structure configured to operate in a tensioned state, having a semicylindrical first sail opening to a first direction and parallel to the first sail, a semicylindrical second sail opening to a second direction opposite to the first direction; said sail structure having an axis for rotation in the middle of the inner edges of the first semicylindrical sail and the second semicylindrical sail, wherein the inner edges are overlapping or connected; transverse bars configured to be fastened to the top edge of the sail structure and to the bottom edge of the sail structure, wherein the transverse bars provide the shape of the first sail and the second sail in the tensioned state; a cable for tensioning the sail structure, and a generator configured to receive the rotation from the sail structure. The power plant further comprises a first sail structure having a first orientation along the axis of rotation; and a second sail structure having a second orientation along the axis of rotation; wherein the difference between the first orientation and the second orientation causes the rotation of the first sail structure and the second sail structure to self-start when subjected to wind. In one embodiment the transverse bars are S-shaped bars transversely to the axis of rotation. In one embodiment the transverse bars are S-shaped bars transversely to the axis of rotation, wherein a bottom portion of the first sail structure comprises a first transverse bar, a top portion of the second sail structure comprises a second transverse bar; and the first transverse bar is connected to the second transverse bar at a different angle, wherein said angles define the difference between the first orientation of the first sail structure and the second orientation of the second sail structure. In one embodiment the difference between the first orientation and the second orientation is 90 degrees. In one embodiment the cable is connected to a bearing, the bearing is connected to a top transverse bar and a top portion of the first sail structure is connected to the top transverse bar, wherein the cable is configured to tension the first sail structure and the second sail structure by providing tension to the top transverse bar when an opposite end of the wind power plant is connected to a fixed support point. In one embodiment the first sail structure and the second sail structure are configured to rotate around the cable; the transverse bars comprise an opening configured to allow the cable to travel through the sail structures and the generator along the axis of rotation; and the cable is connected to a fixed support point in the tensioned state. In one embodiment a bearing is connected onto the cable above the top transverse bar; and the generator is connected to at least one tensioning cable configured to tension the first sail structure and the second sail structure onto the cable. In one embodiment the transverse bars are connected to a bar flange positioned transversely to the axis of rotation. In one embodiment the power plant comprises at least one support flange positioned transversely to the axis of rotation, between the top edge of the sail structure and the bottom edge of the sail structure, wherein the support flange is configured to retain the semicylindrical sail shape in the tensioned state.

Alternatively, or in addition, a method for mounting a dismountable wind power plant with rotation axis substantially perpendicular to the wind direction is disclosed. The wind power plant comprises: a rotating sail structure operating in a tensioned state, having a semicylindrical first sail opening to a first direction and parallel to the first sail, a semicylindrical second sail opening to a second direction opposite to the first direction; said sail structure having an axis for rotation in the middle of the inner edges of the first semicylindrical sail and the second semicylindrical sail, wherein the inner edges are overlapping or connected; transverse bars configured to be fastened to the top edge of the sail structure and to the bottom edge of the sail structure, wherein the transverse bars provide the shape of the first sail and the second sail in the tensioned state; a cable for tensioning the sail structure, and a generator configured to receive the rotation from the sail structure. The method comprises at least two sail structures; a first sail structure having a first orientation along the axis of rotation; a second sail structure having a second orientation along the axis of rotation; wherein the difference between the first orientation and the second orientation causing self-starting the rotation of the first sail structure and the second sail structure when subjected to wind; the first sail structure and the second sail structure rotating around the cable; the transverse bars comprising an opening allowing the cable to travel through the sail structures and the generator along the axis of rotation; connecting the cable to a fixed support point; and tensioning the first sail structure and the second sail structure onto the cable by at least one tensioning cable connected to the generator and to the fixed support point.

Any range or device value given herein may be extended or altered without losing the effect sought.

Although at least a portion of the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that any reference to ‘an’ item refers to one or more of those items.

The steps of the methods described herein may be carried out in any suitable order, or simultaneously where appropriate. Additionally, individual blocks may be deleted from any of the methods without departing from the spirit and scope of the subject matter described herein. Aspects of any of the examples described above may be combined with aspects of any of the other examples described to form further examples without losing the effect sought.

The term ‘comprising’ is used herein to mean including the method blocks or elements identified, but that such blocks or elements do not comprise an exclusive list and a method or apparatus may contain additional blocks or elements.

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from the spirit or scope of this specification.

1-10. (canceled)

11. A dismountable wind power plant with rotation axis substantially perpendicular to the wind direction, comprising:
a rotating sail structure configured to operate in a tensioned state, having a semicylindrical first sail opening to a first direction and parallel to the first sail, a semicylindrical second sail opening to a second direction opposite to the first direction, said sail structure having an axis for rotation in the middle of the inner edges of the first sail and the second sail, wherein the inner edges are overlapping or connected;
transverse bars configured to be fastened to the top edge of the sail structure and to the bottom edge of the sail structure, wherein the transverse bars provide the shape of the first sail and the second sail in the tensioned state;
a cable for tensioning the sail structure, and
a generator configured to receive the rotation from the sail structure,
a first sail structure having a first orientation along the axis of rotation; and
a second sail structure having a second orientation along the axis of rotation; wherein the difference between the first orientation and the second orientation causes the rotation of the first sail structure and the second sail structure to self-start when subjected to wind.

12. A dismountable wind power plant according to claim 11, wherein the transverse bars are S-shaped bars transversely to the axis of rotation.

13. A dismountable wind power plant according to claim 11, wherein the transverse bars are S-shaped bars transversely to the axis of rotation, wherein a bottom portion of the first sail structure comprises a first transverse bar, a top portion of the second sail structure comprises a second transverse bar; and the first transverse bar is connected to the second transverse bar at a different angle, wherein said angles define the difference between the first orientation of the first sail structure and the second orientation of the second sail structure.

14. A dismountable wind power plant according to claim 11, wherein the difference between the first orientation and the second orientation is 90 degrees.

15. A dismountable wind power plant according to claim 11, wherein the cable is connected to a bearing, the bearing is connected to a top transverse bar and a top portion of the first sail structure is connected to the top transverse bar, wherein the cable is configured to tension the first sail structure and the second sail structure by providing tension to the top transverse bar when an opposite end of the wind power plant is connected to a fixed support point.

16. A dismountable wind power plant according to claim 11, wherein the first sail structure and the second sail structure are configured to rotate around the cable; the transverse bars comprise an opening configured to allow the cable to travel through the sail structures and the generator along the axis of rotation; and the cable is connected to a fixed support point in the tensioned state.

17. A dismountable wind power plant according to claim 16, wherein a bearing is connected onto the cable above the top transverse bar; and the generator is connected to at least one tensioning cable configured to tension the first sail structure and the second sail structure onto the cable.

18. A dismountable wind power plant according to claim 11, wherein the transverse bars are connected to a bar flange positioned transversely to the axis of rotation.

19. A dismountable wind power plant according to claim 11, wherein at least one support flange positioned transversely to the axis of rotation, between the top edge of the sail structure and the bottom edge of the sail structure, wherein the support flange is configured to retain the semicylindrical sail shape in the tensioned state.

20. A method for mounting a dismountable wind power plant with rotation axis substantially perpendicular to the wind direction, wherein the wind power plant comprises:
a rotating sail structure operating in a tensioned state, having a semicylindrical first sail opening to a first direction and parallel to the first sail, a semicylindrical second sail opening to a second direction opposite to the first direction,
said sail structure having an axis for rotation in the middle of the inner edges of the first semicylindrical sail and the second semicylindrical sail, wherein the inner edges are overlapping or connected;
transverse bars configured to be fastened to the top edge of the sail structure and to the bottom edge of the sail structure, wherein the transverse bars provide the shape of the first sail and the second sail in the tensioned state;
a cable for tensioning the sail structure, and
a generator configured to receive the rotation from the sail structure, wherein the wind power plant comprises at least two sail structures;
a first sail structure having a first orientation along the axis of rotation;
a second sail structure having a second orientation along the axis of rotation; wherein the difference between the first orientation and the second orientation causing self-starting the rotation of the first sail structure and the second sail structure when subjected to wind;
the first sail structure and the second sail structure rotating around the cable;
the transverse bars comprising an opening allowing the cable to travel through the sail structures and the generator along the axis of rotation; connecting the cable to a fixed support point; and
tensioning the first sail structure and the second sail structure onto the cable by at least one tensioning cable connected to the generator and to the fixed support point.
